(19) United States
(12) Patent Application Publication
(10) Pub. No.: US 2025/0165061 A1
(43) Pub. Date: May 22, 2025

(54) INFORMATION PROCESSING DEVICE, INFORMATION PROCESSING METHOD, AND PROGRAM

(71) Applicant: OMRON Corporation, Kyoto-shi, KYOTO (JP)

(72) Inventors: Masahiro AKAGI, Kyoto-shi, KYOTO (JP); Hiroyuki IBUKI, Kyoto-shi, KYOTO (JP)

(21) Appl. No.: 18/841,751

(22) PCT Filed: Jan. 18, 2023
(86) PCT No.: PCT/JP2023/001401

§ 371 Date: Aug. 27, 2024

(30) Foreign Application Priority Data
Mar. 10, 2022 (JP) 2022-037312

(51) Int. Cl. G06F 3/01

(52) U.S. Cl. CPC G06F 3/012; G06F 3/017

(57) ABSTRACT

An information processing device includes a display unit for displaying a movable indicator, a detector for detecting the direction of the face of a user, and a movement controller for suppressing the indicator from moving on the display unit, when the direction of the face of the user detected by the detector is a direction within a predetermined angle range with respect to the forward direction.

### TECHNICAL FIELD

The present invention relates to an information processing device, an information processing method, and a program relating to manipulations using face detection.

### BACKGROUND ART

There have been suggested various types of techniques for manipulating an information processing device such as a personal computer, based on results of detection of person's face and detection of person's motions such as gestures, by capturing images of the person by an imaging device such as a camera.

Patent Document 1 suggests a technique for facilitating manipulations through detection of a specific gesture when a user performs manipulations through gestures. Further, Patent Document 2 suggests a technique for providing a method alternative to a mouse, which enables a physically handicapped person lame in both hands to manipulate programs through a graphical user interface (GUI) without being required to wear a wearing object.

### CITATION LIST

### Patent Literature

Patent Document 1: Japanese Unexamined Patent Publication No. 2017-004553
Patent Document 2: Japanese Unexamined Patent Publication No. 2007-310914

### SUMMARY OF INVENTION

### Problems to be Solved by Invention

However, in cases of moving an indicator such as a pointer displayed on a display according to the direction of the user's face using the aforementioned conventional techniques, if the user unintentionally directs his or her face in a direction different from the direction in which the user desires to move the indicator, this causes the indicator to move in a direction not desired by the user according to the direction of the user's face. This may cause the user to feel poor usability.

For coping therewith, the present invention has been made in view of the aforementioned circumstances, and aims at providing a technique for improving movement control of an indicator on a display unit according to the direction of user's face.

### Means for Solving the Problem

In order to achieve the aforementioned aim, the present invention adopts the following structures.

In one aspect of the present invention, there is provided an information processing device including a display unit for displaying a movable indicator, a detector for detecting the direction of the face of a user, and a movement controller for suppressing the indicator from moving on the display unit, when the direction of the face of the user detected by the detector is a direction within a predetermined angle range with respect to a forward direction. Accordingly, even in a case where the user unintentionally directs his or her face in a direction different from the direction in which the user desires to move the indicator on the display unit, if the angle of the direction of the face with respect to the forward direction is small, the indicator of the display unit is prevented from moving. This can suppress a phenomenon that the user unintentionally moves his or her face to move the indicator.

Further, the aforementioned information processing device may further include a notifying unit configured to notify the user that the indicator is suppressed from moving, when the direction of the face of the user detected by the detector is a direction within the predetermined angle range with respect to the forward direction. This enables the user to grasp whether or not the indicator displayed on the display unit can be moved with the current direction of the face. Further, in the aforementioned information processing device, the movement controller may change the predetermined angle range according to a distance between the detector and the user. Thus, when the user is closer to the detector, it is possible to increase the angle as the threshold value in the predetermined angle range. When the user is farther from the detector, it is possible to decrease the angle as the threshold value. This can optimize the sensitivity of starting the movement of the indicator when the user has moved the direction of his or her face.

Further, the present invention can also be regarded as information processing methods including at least a part of the aforementioned processes, programs for causing a computer to execute these methods, or computer-readable recording mediums storing such programs in non-transient manner. The aforementioned structures and processes can be combined with each other to structure the present invention, as long as no technical inconsistency occurs.

### Effect of Invention

According to the present invention, it is possible to improve control of movement of an indicator on a display unit according to the direction of user's face.

### BRIEF DESCRIPTION OF THE DRAWINGS

FIG. 1 is a view schematically illustrating an example of the structure of a PC to which the present invention is applied.

FIG. 2 is a block diagram illustrating an example of the PC according to one embodiment.

FIG. 3 is a flowchart illustrating an example of a process flow in the PC according to one embodiment.

FIG. 4 is a flowchart illustrating an example of a process flow in the PC according to one embodiment.

FIG. 5A and FIG. 5B are examples of a display on a display unit, and an image of a user which is outputted from a camera according to one embodiment.

FIGS. 6A to 6D are examples of displays on the display unit, and images of the user which are outputted from the camera according to one embodiment.

### MODE FOR CARRYING OUT INVENTION

### Example of Applications

There will be described an example of application of the present invention. According to the conventional techniques, in cases of moving an indicator such as a pointer displayed on a display according to the direction of the user's face, if the user unintentionally directs his or her face in a direction different from the direction in which the user desires to move the indicator, this causes the indicator to move in a direction not desired by the user according to the direction of the user's face. This may cause the user to feel poor usability.

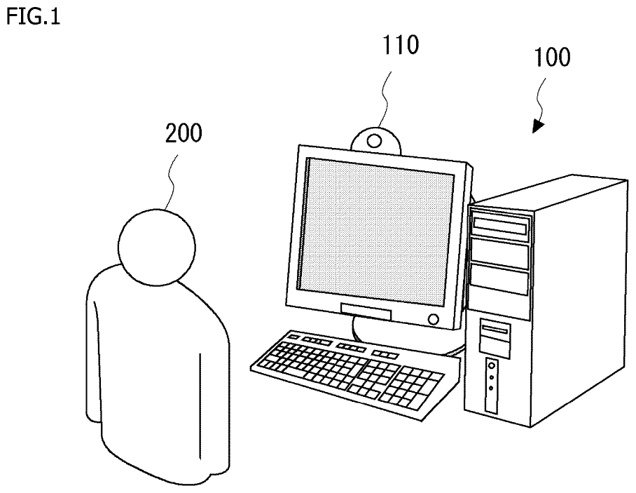

FIG. 1 is a view schematically illustrating an example of the structure of a PC 100 to which the present invention is applied. In the example of the structure illustrated in FIG. 1, the PC 100 includes a camera 110. The camera 110 has a function of capturing an image of the face of a user 200 of the PC 100. The PC 100 processes the image of the face of the user 200 captured by the camera 110 to identify the direction of the face of the user 200, and controls movement of an indicator such as a pointer displayed on a display unit such as a display of the PC 100, according to the direction of the face of the user 200. Incidentally, the contents of processes executed by the PC 100 will be described later specifically.

The PC 100 performs a face detection process on the image of the face of the user 200 captured by the camera 110. If the identified direction of the face of the user 200 falls within a predetermined angle range from the forward direction, the PC 100 suppresses the indicator from moving on the display unit. Accordingly, even in a case where the user 200 unintentionally directs his or her face in a direction different from the direction in which the user desires to move the indicator on the display unit in the PC 100, if the angle of the direction of the face with respect to the forward direction is small, the indicator is prevented from moving. This can suppress a phenomenon that the user 200 erroneously moves his or her face to move the indicator.

### DESCRIPTION OF EMBODIMENTS

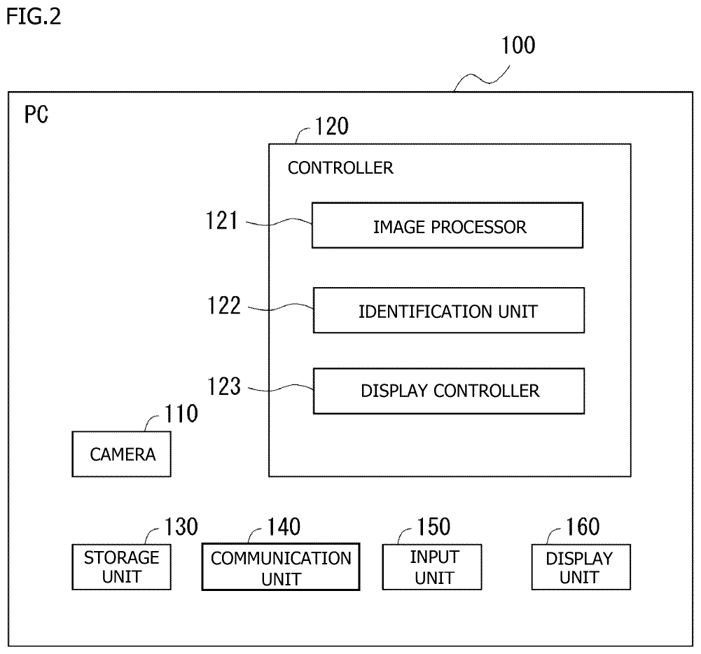

A first embodiment of the technique according to the present disclosure will be described. As an example of an information processing device according to the present embodiment, the PC 100 including the camera 110 illustrated in FIG. 1 is assumed. FIG. 2 is a block diagram illustrating an example of the structure of the PC 100 according to the present embodiment. As illustrated in FIG. 2, the PC 100 includes the camera 110, a controller 120, a storage unit 130, a communication unit 140, an input unit 150, and a display unit 160.

The camera 110 functions as a detector for detecting the direction of the face of the user 200. Thus, the camera 110 captures an image of the face of the user 200 using the PC 100, and outputs the captured image to the controller 120. The controller 120 includes a central processing unit (CPU), a random access memory (RAM), a read only memory (ROM), and the like, and performs control of the respective units in the PC 100, various information processes, and the like. The controller 120 includes an image processor 121, an identification unit 122, and a display controller 123. The image processor 121 executes a process for detecting the face of the user 200 by processing the image outputted from the camera 110. The identification unit 122 identifies the direction of the face of the user 200 based on the result of the face detection process by the image processor 121, and executes a process for determining whether or not to suppress the movement of the indicator displayed on the display unit 160 based on the identified direction of the face. The display controller 123 forms a movement controller for executing a process for controlling movement of the indicator displayed on the display unit 160 based on the result of the determination process by the identification unit 122. The display controller 123 also forms a notifying unit for notifying the user that the indicator displayed on the display unit 160 is suppressed from moving. In the following description, the movement of the indicator is stopped as the suppression of the movement of the indicator. However, it is also possible to perform movement control such as reduction of the moving speed of the indicator, instead of stop of movement of the indicator, as the suppression of the movement.

The storage unit 130 stores programs to be executed by the controller 120, various types of data to be used in processes executed by the controller 120, and the like. For example, the storage unit 130 is an auxiliary storage device such as a hard disk drive or a solid state drive.

The communication unit 140 communicates with various devices (not illustrated) outside the PC 100. The input unit 150 can be manipulated by the user of the PC 100, and has a function of inputting instructions relating to processes executed by the controller 120. Examples of the input unit 150 include a keyboard and a pointing device. The display unit 160 displays information relating to results of processes by the controller 120. Incidentally, information relating to results of processes by the controller 120 may be stored in the storage unit 130 and displayed on the display unit 160 at arbitrary timing.

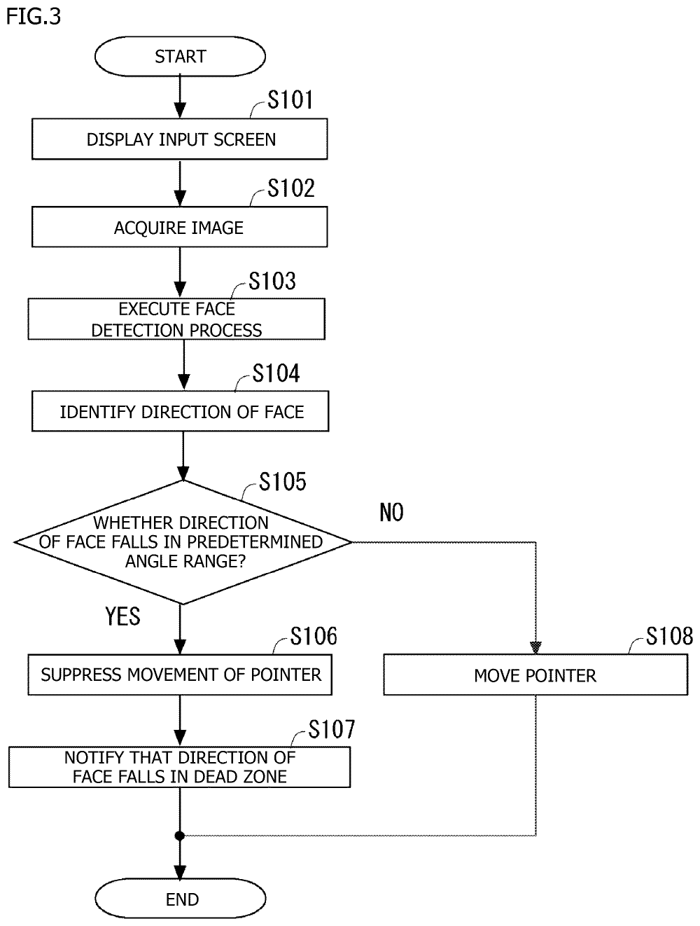

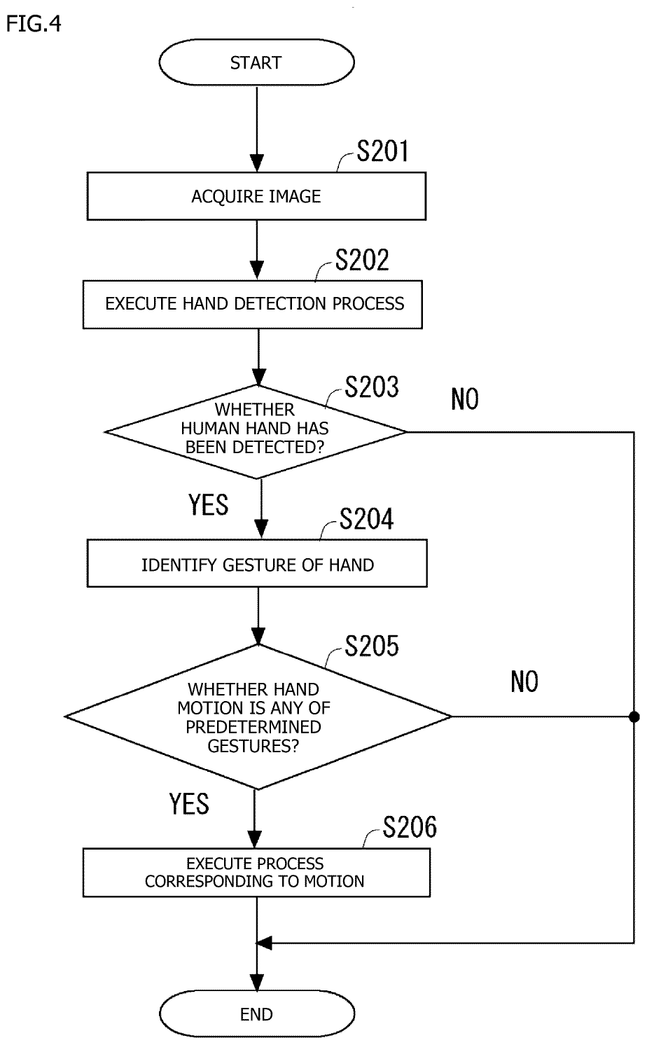

FIGS. 3 and 4 are flowcharts illustrating examples of process flows in the PC 100. As an example, it is assumed that the user 200 of the PC 100 moves the pointer with respect to a keyboard displayed on the display unit 160 and performs inputting therewith, by manipulating the input unit 150 in the PC 100. The PC 100 executes the process of the flowchart illustrated in FIG. 3 and the process of the flowchart illustrated in FIG. 4 in parallel. First, with reference to FIG. 3, there will be described the process executed by the controller 120. As an example, the controller 120 executes the process of the flowchart in FIG. 3 for each image outputted from the camera 110. However, the controller 120 is not required to execute the process of the flowchart in FIG. 3 for all the images outputted from the camera 110, and may execute the process intermittently, in such a way as to execute the process every time a predetermined number of images have been outputted from the camera 110 or to execute the process for images outputted from the camera 110 at predetermined time intervals.

In a step S101, the display controller 123 in the controller 120 displays an input screen on the display unit 160. At this time, the display controller 123 also displays, on the display unit 160, a pointer as an indicator movable by user's manipulations. Incidentally, examples of the display of the input screen and the pointer on the display unit 160 will be described, later.

In a step S102, the controller 120 acquires, from the camera 110, an image captured by the camera 110. In this case, the face of the user 200 falls within the image-capturing range of the camera 110 and, therefore, the camera 110 captures an image of the face of the user 200 and outputs the captured image to the controller 120.

Next, in a step S103, the image processor 121 in the controller 120 executes a face detection process on the image received from the camera 110 in the step S102. Since the image captured by the camera 110 includes the face of the user 200, the face of the user 200 is detected from the image by the process in the step S103.

Next, in a step S104, the identification unit 122 in the controller 120 calculates the angle of the face of the user 200 with respect to the forward direction with respect to the camera 110, based on the relative positions of feature points on respective organs such as the eyes, nose, mouth, and ears in the face of the user 200 detected in the step S103, thereby identifying the direction of the face of the user 200. Examples of the feature points include an edge of an eye, a tip of the jaw, a tip of the nose, an edge of the mouth, but the feature points are not limited thereto. The calculation of the angle indicating the direction of the face can be realized based on the aforementioned feature points using a known technique and, thus, is not described in detail here.

Next, in a step S105, the identification unit 122 determines whether or not the angle indicating the direction of the face of the user 200 identified in the step S104 falls within a predetermined angle range. Here, the predetermined angle range is a range of the angle of the direction of the face as follows. That is, even if the user 200 changes the direction of his or her face from the forward direction with respect to the camera 110 within the predetermined angle range, the controller 120 does not move the pointer displayed on the display unit 160. Therefore, as the predetermined angle range is increased, the user 200 changes the direction of his or her face more greatly from the forward of the camera 110 to cause the controller 120 to release the stop of the pointer on the display unit 160, thereby starting movement of the pointer. Furthermore, as the predetermined angle range is decreased, the user 200 changes the direction of his or her face smaller from the forward of the camera 110 to cause the controller 120 to release the stop of the pointer on the display unit 160, thereby starting movement of the pointer. Accordingly, the predetermined angle range may be appropriately changed according to the range within which the direction of the face of the user 200 is movable. Incidentally, in the following description, this predetermined angle range will be referred to as a “dead zone”, wherein even if the user 200 changes the direction of his or her face within the dead zone, the pointer is prevented from moving.

If the angle indicating the direction of the face of the user 200 falls within the dead zone (S105: YES), the identification unit 122 advances the process to a step S106. On the other hand, if the angle indicating the direction of the face of the user 200 does not fall within the dead zone (S105: NO), the identification unit 122 advances the process to a step S108.

In the step S106, the display controller 123 in the controller 120 performs control for suppressing movement of the pointer displayed on the display unit 160. Specifically, the display controller 123 maintains the pointer displayed on the display unit 160 at a state of being stopped at the position where the pointer is being currently displayed. Then, the controller 120 advances the process to a step S107.

In the step S107, the display controller 123 performs, on the display unit 160, display for providing notification that the direction of the user's face falls in the dead zone. Incidentally, an example of the display on the display unit 160 which is performed by the display controller 123 will be described later.

Furthermore, in the step S108, the display controller 123 performs control for moving the pointer displayed on the display unit 160. Specifically, the display controller 123 moves the pointer displayed on the display unit 160 from the position where the pointer is being currently displayed, by using a moving direction and a moving speed determined based on the direction of the face of the user 200 identified in the step S104.

Here, as an example, regarding the moving speed of the pointer, assuming that the number of pixels across which the pointer moves per frame based on the frame rate of the display unit 160 is p, the angle of the direction of the face of the user 200 is a, and the angle as the threshold value within the dead zone (the maximum angle within the angle range regarded as the dead zone) is p, the value of p calculated by the following equation (1) can be set as the moving speed of the pointer.

$$[ Equation 1 ]$$

$$p = sign ( α ) \times max [ \{ abs ( α ) - β \} , 0 ] \times {\{ abs ( α ) \times c \}}^{2} \qquad ( 1 )$$

Here, c is a variable constant, and the moving speed of the pointer can be adjusted by varying the value of c.

After the completion of the process in the step S107 or S108, the controller 120 ends the process of the flowchart in FIG. 3 and repeatedly executes the process of the flowchart in FIG. 3 on another image outputted from the camera 110.

Next, with reference to the flowchart in FIG. 4, there will be described processes executed by the controller 120. In the present embodiment, it is assumed that processes to be executed by the controller 120 are associated with hand gestures identified in the process which will be described below. Further, it is assumed that information indicating the correspondence between hand gestures and processes to be executed is preliminarily stored in the storage unit 130. As an example, in the flowchart in FIG. 4, the controller 120 executes the process of the flowchart in FIG. 4 for a plurality of images outputted sequentially from the camera 110, and the PC 100 is processed based on a hand gesture identified from the series of images. Incidentally, it is possible to appropriately set the timing of execution of the processes of the flowcharts in FIGS. 3 and 4, and the images for which these processes are executed.

First, in a step S201, the controller 120 acquires, from the camera 110, an image captured by the camera 110. Here, similarly to in execution of the process of the flowchart in FIG. 3, the camera 110 captures an image of the face of the user 200 and outputs the captured image to the controller 120.

In a step S202, the image processor 121 executes a hand detection process for detecting a human hand on each image acquired in the step S201. Next, in a step S203, the image processor 121 determines whether or not a human hand has been detected in the process in the step S202. If a human hand has been detected in the image (S203: YES), the image processor 121 advances the process to a step S204. For example, if the image includes no hand of the user 200 since the user 200 has lowered his or her hand, the image processor 121 cannot detect the hand from the image through the hand detection process. Therefore, if no hand has been detected in the image (S203: NO), the image processor 121 ends the process of this flowchart.

Next, in the step S204, the identification unit 122 identifies what gesture is made by the motion of the hand in each image, which has been detected in the step S202. Examples of the hand gesture identified in this case include well-known gestures such as a palm spreading gesture, a fist clenching gesture, a hand shaking gesture, and gestures using the fingers. After identifying the gesture, the identification unit 122 advances the process to a step S205.

In step the S205, the identification unit 122 determines whether or not the hand motion identified in the step S204 is any of predetermined gestures. Here, the predetermined gestures are gestures associated with processes to be executed by the controller 120. As described above, the information indicating the correspondence between hand gestures and processes to be executed is stored in the storage unit 130. Therefore, the identification unit 122 refers to the information stored in the storage unit 130 and determines whether or not the hand motion identified in the step S204 is any of the predetermined gestures indicated by the referred information. If the identified hand motion is any of the predetermined gestures (S205: YES), the identification unit 122 advances the process to a step S206. On the other hand, if the identified hand motion is not any of the predetermined gestures (S205: NO), the identification unit 122 ends the process of this flowchart. Further, in the step S206, the controller 120 refers to the information indicating the correspondence between the hand gestures and the processes to be executed, which is stored in the storage unit 130. Further, the controller 120 executes the process corresponding to the gesture identified in the step S204. After the completion of the process in the step S206, the controller 120 ends the process of the flowchart in FIG. 4. Then, the controller 120 repeatedly executes the process of the flowchart in FIG. 4 for another series of images outputted from the camera 110.

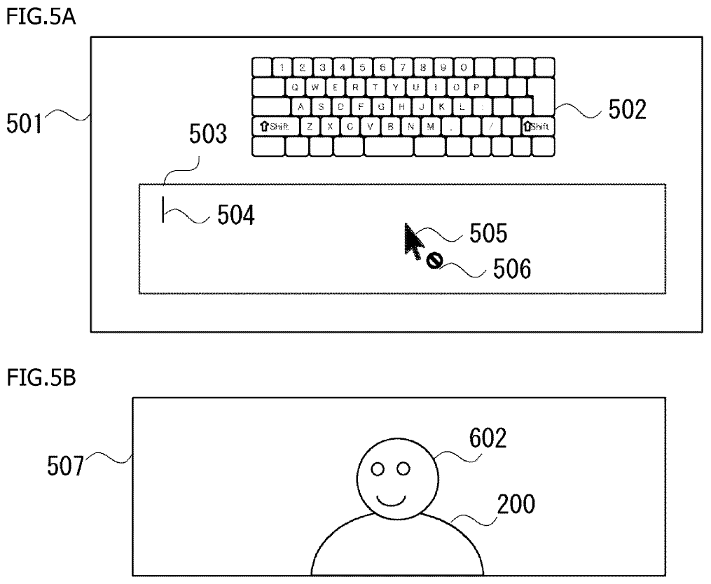

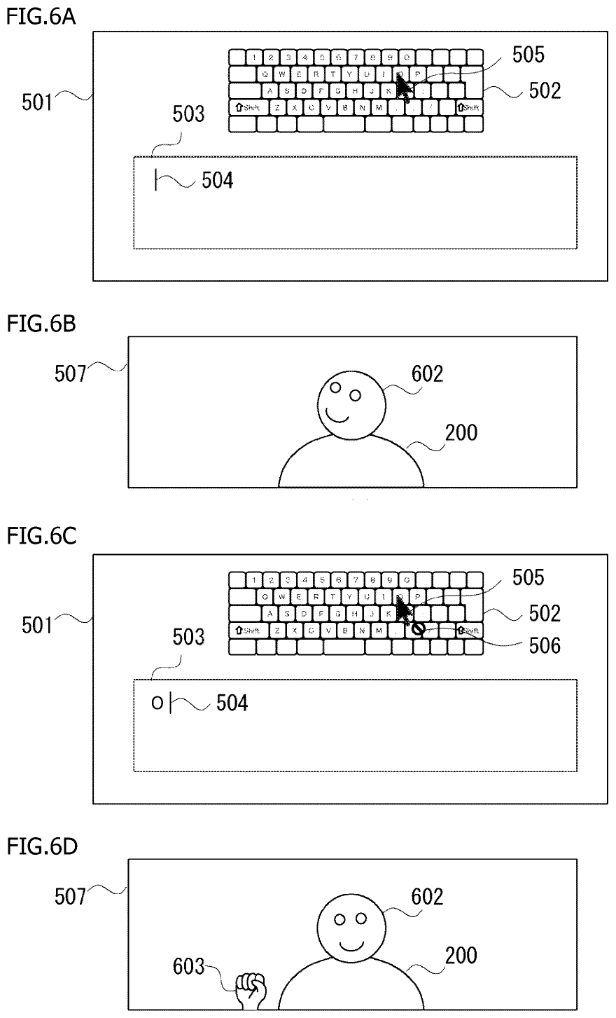

Next, with reference to FIGS. 5A, 5B, and 6A to 6D, there will be described examples of screens displayed on the display unit 160, and images of the user 200 which are outputted from the camera 110, when the aforementioned process is executed. As illustrated in FIG. 5A, a keyboard 502, an input area 503, and a pointer 505 are displayed in an input screen 501 displayed on the display unit 160. The input area 503 is an area where characters and the like are inputted according to key inputting performed on the keyboard 502. A cursor 504, which is a position at which a character is inputted, is also displayed in the input area 503. Here, it is assumed that the position of the pointer 505 in FIG. 5A is the initial position of the pointer 505. Incidentally, the user 200 can also move the pointer 505 to a desired position to change the initial position to the position of the pointer 505 having been moved, by manipulating the input unit 150.

FIG. 5B is an image 507 of the user 200 which is outputted from the camera 110 when the display of the input screen 501 is in the state illustrated in FIG. 5A. As illustrated in FIG. 5B, in the image 507, the user 200 has slightly shifted the direction of his or her face 602 from the forward of the camera, and it is assumed that the angle of the direction of the face 602 falls in the dead zone, at this time. In the case illustrated in FIG. 5A and FIG. 5B, in the process of the flowchart in FIG. 3, it is determined in the step S105 that the angle indicating the direction of the face of the user 200 falls within the dead zone (S105: YES). As a result, even though the user 200 has shifted the direction of his or her face 602 from the forward of the camera 110, the pointer 505 is kept stopped in the input screen 501 by the display controller 123 (step S106), and an icon 506 as an indicator indicating that the pointer 505 is suppressed from moving (the pointer 505 is stopped, in this case) is displayed in the input screen 501 (step S107). This enables the user 200 to recognize that the pointer 505 cannot move with the current direction of the face 602, by checking the input screen 501.

Next, after the state of FIG. 5B, as illustrated in FIG. 6B, it is assumed that, in the image 507 outputted from the camera 110, the user 200 has further shifted the direction of his or her face 602 from the forward, and the angle of the direction of the face 602 does not fall in the dead zone. In this case, in the process of the flowchart in FIG. 3, it is determined in the step S105 that the angle indicating the direction of the face of the user 200 does not fall within the dead zone (S105: NO). As a result, as illustrated in FIG. 6A, the pointer 505 moves in the input screen 501 in a moving direction and at a moving speed, wherein the moving direction and the moving speed are determined based on the direction of the face 602 of the user 200 (step S108). Incidentally, in the case illustrated in FIG. 6A and FIG. 6B, the user 200 directs his or her face 602 in an upward and rightward direction toward the camera 110, the pointer 505 moves in the input screen 501, in an upward and rightward direction, from the position illustrated in FIG. 5A. Furthermore, in a state where the angle indicating the direction of the face of the user 200 does not fall within the dead zone, the display controller 123 brings the icon 506, which has been displayed by the pointer 505 in FIG. 5A, into a state of not being displayed.

Furthermore, it is assumed that, when the user 200 has moved the pointer 505 to a desired position on the keyboard 502 in the input screen 501 as illustrated in FIG. 6A, the user 200 returns the direction of his or her face 602 to the forward of the camera 110, and moves his or her hand 603 to within the image-capturing range of the camera 110 and makes a gesture (a fist clenching behavior, in this case), as illustrated in FIG. 6D. Furthermore, in this case, it is assumed that a fist clenching gesture is associated with a process for pressing a key in the keyboard 502 in the input screen 501. In this case, in the process of the flowchart in FIG. 3, it is determined in the step S105 that the angle indicating the direction of the face of the user 200 falls within the dead zone (S105: YES). As a result, the pointer 505 is kept stopped in the input screen 501 by the display controller 123 (step S106), and the icon 506, which is an indicator indicating that the pointer 505 cannot move, is displayed in the input screen 501 (step S107).

Furthermore, in the state illustrated in FIG. 6D, it is determined that the fist clenching gesture is one of the predetermined gestures in the aforementioned process of the flowchart in FIG. 4 (step S205), and the process corresponding to the determined gesture (the process for pressing a key in the keyboard 502, in this case) is executed (S206). As a result, as illustrated in FIG. 6C, in the input screen 501, the key in the keyboard 502 on which the pointer 505 is positioned is pressed to input a character to the input area 503. Therefore, since the pointer 505 does not move with the current direction of the face 602 (FIG. 6D), it is possible to suppress the phenomenon that the pointer 505 is displaced from a desired position because the user 200 unintentionally displaces his or her face 602 from the forward after moving the pointer 505 to the desired position in the input screen 501. As a result, the user 200 can accurately perform manipulations for inputting characters using the keyboard 502 by moving the pointer 505 while changing the direction of the face 602.

### Others

The aforementioned embodiment merely describes an example of the structure of the present invention, in an illustrative manner. The present invention is not limited to the aforementioned specific aspect, and various changes can be made thereto within the scope of the technical idea. For example, in the PC 100 according to the aforementioned embodiment, in a case where the direction of the face of the user 200 falls in the dead zone, the icon 506 is displayed on the display unit 160 as an indicator for notifying the user 200 of this fact. However, instead thereof or in addition thereto, the input screen 501 can be partially changed in display or an alarm can be given to the user 200 through sound using a speaker (not illustrated) or the like connected to the PC 100, in order to provide notification that the direction of the face of the user 200 falls in the dead zone.

Furthermore, in the aforementioned embodiment, the angle range of the direction of the face which defines the dead zone may be changed according to the distance between the camera 110 and the user 200. For example, in the step S102, the controller 120 calculates the distance between the camera 110 and the user 200 based on the size of the face of the user 200 in an image acquired from the camera 110, and changes the angle of the direction of the face which serves as the threshold value for determining that the direction of user's face falls in the dead zone in the step S105, according to the calculated distance. Consequently, when the user 200 is closer to the camera 110, it is possible to increase the angle as the threshold value for deeming that the direction of user's face falls in the dead zone. When the user 200 is farther from the camera 110, it is possible to decrease the angle as the threshold value for deeming that the direction of user's face falls in the dead zone. This raises expectations for optimization of the sensitivity of starting the movement of the pointer 505 when the user 200 has moved the direction of his or her face.

Further, in the aforementioned embodiment, the moving speed of the pointer 505 may be determined according to the screen size of the display unit 160. For example, before starting the process of the flowcharts in FIGS. 3 and 4, the controller 120 may acquire information about the screen size of the display unit 160 and may change the value of c in the aforementioned formula (1) according to the screen size. This enables setting the moving speed of the pointer 505 larger as the screen size is larger. This can suppress a phenomenon that a longer time is required to move the pointer 505 in the screen, even when the screen size is larger. This can raise expectations for improvement of the work efficiency in moving the pointer 505 depending on the direction of the face.

### <Remark 1>

An information processing device (100) including:
a display unit (160) for displaying a movable indicator;
a detector (110) for detecting the direction of the face of a user; and
a movement controller (123) for suppressing the indicator from moving on the display unit, when the direction of the face of the user detected by the detector is a direction within a predetermined angle range with respect to a forward direction.

### <Remark 2>

An information processing method including:
a display step (S101) of displaying a movable indicator on a display unit;
a detection step (S104) of detecting the direction of the face of a user; and
a movement control step (S106) of suppressing the indicator from moving on the display unit, when the detected direction of the face of the user is a direction within a predetermined angle range with respect to a forward direction.

### DESCRIPTION OF SYMBOLS

100 PC, 110 camera, 120 controller, 121 image processor, 122 identification unit, 123 display controller, 160 display unit

1. An information processing device comprising:
a display unit configured to display a movable indicator;
a detector configured to detect a direction of a face of a user; and
a movement controller configured to suppress the indicator from moving on the display unit, when the direction of the face of the user detected by the detector is a direction within a predetermined angle range with respect to a forward direction.

2. The information processing device according to claim 1, further comprising a notifying unit configured to notify the user that the indicator is suppressed from moving, when the direction of the face of the user detected by the detector is the direction within the predetermined angle range with respect to the forward direction.

3. The information processing device according to claim 1, wherein the movement controller changes the predetermined angle range according to a distance between the detector and the user.

4. An information processing device comprising:
a display step of displaying a movable indicator on a display unit;
a detection step of detecting a direction of a face of a user; and
a movement control step of suppressing the indicator from moving on the display unit, when the detected direction of the face of the user is a direction within a predetermined angle range with respect to a forward direction.

5. A non-transitory computer readable medium storing a program for causing a computer to execute operations comprising:
a display step of displaying a movable indicator on a display unit;
a detection step of detecting a direction of a face of a user; and
a movement control step of suppressing the indicator from moving on the display unit, when the detected direction of the face of the user is a direction within a predetermined angle range with respect to a forward direction.
